(19) United States
(12) Patent Application Publication
(10) Pub. No.: US 2008/0238189 A1
(43) Pub. Date: Oct. 2, 2008

(54) System and method for vacuum booster assist

(76) Inventors: Ching-Chuang G. Kuo, South Lyon, MI (US); Deron C. Littlejohn, West Bloomfield, MI (US)

Correspondence Address: DELPHI TECHNOLOGIES, INC., M/C 480-410-202, PO BOX 5052, TROY, MI, 48007, US

(21) Appl. No.: 11/728,871

(22) Filed: Mar. 27, 2007

(51) Int. Cl. B60T 8/44

(52) U.S. Cl. 303/114.3

(57) ABSTRACT

A system for vacuum booster assist including a vacuum booster having an input and an output, a brake pedal connected to the input of the vacuum booster, a brake pedal travel sensor positioned to monitor travel of the brake pedal, a master cylinder having an input and an output, the input of the master cylinder being connected to the output of the vacuum booster, a master cylinder pressure sensor connection to the master cylinder to monitor a fluid pressure in the master cylinder, a brake fluid pressurizing device in fluid communication with the output of the master cylinder, and a controller in communication with the brake pedal travel sensor, the master cylinder pressure sensor and the brake fluid pressurizing device, wherein the controller is adapted to communicate a command signal to the brake fluid pressurizing device based upon signals received from the brake pedal travel sensor and the master cylinder pressure sensor.

### BACKGROUND

The present application is directed to vacuum booster assist systems and methods and, more particularly, to vacuum booster assist systems and methods capable of operating without a vacuum sensor.

A typical vacuum booster assist system is a braking device for electrically augmenting the brake pressure to assist a driver's braking capability when the booster has reached its run-out point or when the vacuum level of the vehicle is low (e.g., high altitudes or loss of engine power). Vacuum booster assist systems also provide better braking performance at high vehicle weight and can be used in the brake system design to allow for downsizing of the brake system booster for cost reduction or packaging space considerations.

Typically, vacuum booster assist systems require installation of vacuum sensors on the booster to detect vacuum run-out conditions and a brake pedal force sensor to know the driver's desired braking. Based on the run-out condition, a controller may automatically generate desired brake pressures to compensate for the missing boost gain and more accurately achieve the driver's braking intention. However, the addition of vacuum sensors substantially increases manufacturing costs.

Prior art vacuum booster assist systems have not addressed the cost and manufacturing issues and, therefore, have not been widely adopted. For example, one prior art vacuum booster assist system employs a mathematical model to estimate the booster chamber vacuum pressure and brake pedal force based upon measured values of the manifold absolute pressure and the master cylinder pressure. Unfortunately, this system does not ease the concerns on issues of reliability and robustness from OEM car makers.

Another prior art vacuum booster assist system uses a single gauge vacuum sensor on the apply chamber of the vacuum booster to detect the vacuum run-out and the measured master cylinder pressure to determine the driver's intended brake effort. However, this system is still disadvantaged by significant costs for material and manufacturing related to the vacuum sensor installation.

Accordingly, there is a need for a vacuum booster assist system that is reliable, robust and low cost.

### SUMMARY

In one aspect, the disclosed system for vacuum booster assist may include a vacuum booster having an input and an output, a brake pedal connected to the input of the vacuum booster, a brake pedal travel sensor positioned to monitor travel of the brake pedal, a master cylinder having an input and an output, the input of the master cylinder being connected to the output of the vacuum booster, a master cylinder pressure sensor connection to the master cylinder to monitor a fluid pressure in the master cylinder, a brake fluid pressurizing device in fluid communication with the output of the master cylinder, and a controller in communication with the brake pedal travel sensor, the master cylinder pressure sensor and the brake fluid pressurizing device, wherein the controller is adapted to communicate a command signal to the brake fluid pressurizing device based upon signals received from the brake pedal travel sensor and the master cylinder pressure sensor.

In another aspect, the disclosed method for assisting a vacuum booster assembly apply a braking force to a brake unit includes the steps of providing a brake fluid pressurizing device, monitoring the travel of the brake pedal, monitoring the pressure in the master cylinder, correlating the monitored travel and the monitored pressure to an estimated vacuum pressure of the vacuum booster and, when the estimated vacuum pressure exceeds a predetermined threshold value, actuating the brake fluid pressurizing device to increase the braking force.

Other aspects of the disclosed system and method for vacuum booster assist will become apparent from the following description, the accompanying drawings and the appended claims.

### BRIEF DESCRIPTION OF THE DRAWINGS

FIG. 1 is a block diagram of one aspect of the disclosed system for vacuum booster assist;

FIG. 2 is a graphical illustration of vacuum pressure, master cylinder pressure, pedal travel and the ratio of master cylinder pressure to pedal travel plotted versus time for the system of FIG. 1;

FIG. 3 is a flow chart depicting the operation of the vacuum booster assist system of FIG. 1;

FIG. 4 is a graphical illustration of master cylinder pressure, pedal travel, activation of the vacuum booster assist system of FIG. 1 and the resulting downstream brake pressure output plotted versus time; and

FIG. 5 is a graphical comparison of downstream brake pressure output versus input pedal force for a vehicle operating with and without the vacuum booster assist system of FIG. 1 under idle power and no power conditions.

### DETAILED DESCRIPTION

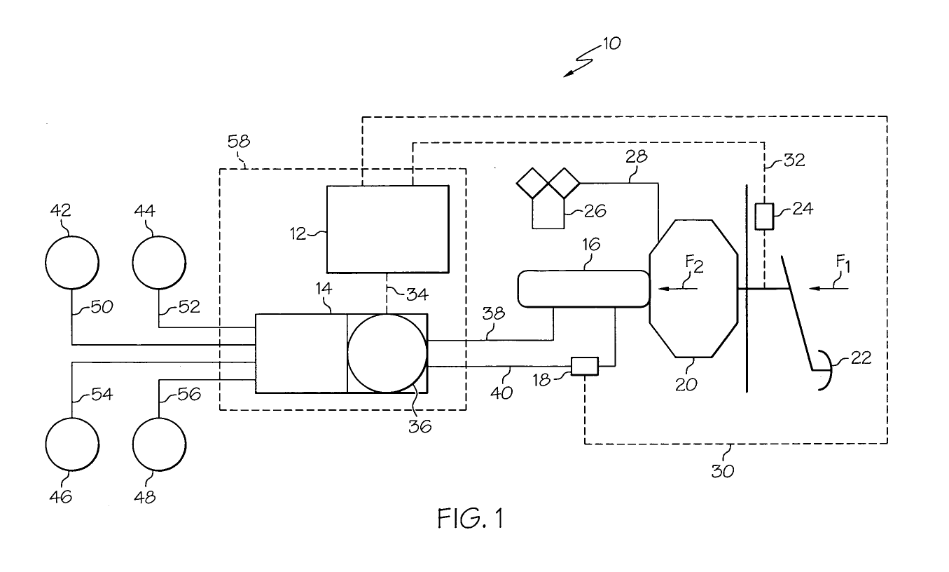

Referring to FIG. 1, one aspect of the disclosed vacuum booster assist system, generally designated 10, may include a controller 12, a hydraulic modulator assembly 14, a master cylinder 16, a master cylinder pressure sensor 18, a vacuum booster 20, a brake pedal 22 and a brake pedal travel sensor 24. The brake pedal 22 may supply an input braking force F₁ to the vacuum booster 20 and, in turn, the vacuum booster 20 may supply an amplified input force F₂ to the master cylinder 16 when a vacuum is applied to the vacuum booster 20 by a vacuum source 26. The vacuum source 26 may be an engine, a pump or the like and may be connected to the vacuum booster 20 by a vacuum line 28.

The controller 12 may receive input signals from the master cylinder pressure sensor 18 by way of a communication line 30 and from the brake pedal travel sensor 24 by way of a communication line 32. The controller 12 may process the signals received from the master cylinder pressure sensor 18 and the brake pedal travel sensor 24 and may communicate an output command signal to the hydraulic modulator assembly 14 by way of communication line 34. The communication lines 30, 32, 34 may be one or two-way communication lines, hard-wired communication lines, communications buses, wireless communication lines or the like.

The hydraulic modulator assembly 14 may include an electric pump 36 and may be in communication with the master cylinder 16 by way of fluid lines 38, 40 and the brake units 42, 44, 46, 48 by way of fluid lines 50, 52, 54, 56. Brake unit 42 may be associated with a left front wheel of a vehicle, brake unit 44 may be associated with a right front wheel of a vehicle, brake unit 46 may be associated with a left rear wheel of a vehicle and brake unit 48 may be associated with a right rear wheel of a vehicle.

In one aspect, the controller 12 and/or the hydraulic modulator assembly 14 may be associated with an anti-lock braking system 58 (“ABS”) of a vehicle (not shown). However, those skilled in the art will appreciate that the disclosed vacuum booster assist system 10 may be implemented using any brake fluid pressurizing device (i.e., any device or system capable of increasing braking force (e.g., increasing pressure in the brake lines 50, 52, 54, 56) downstream of the master cylinder 16).

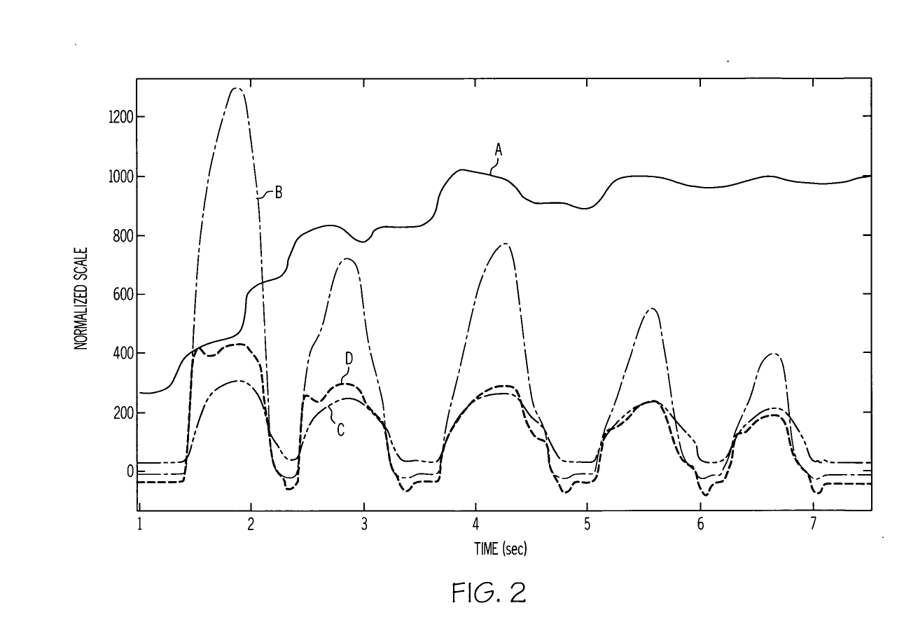

Referring to FIG. 2, the vacuum pressure versus time (i.e., the pressure in the vacuum booster 20 as applied by the vacuum source 26) is shown by line A, the master cylinder pressure versus time, as determined by the master cylinder pressure sensor 18, is shown by line B, the pedal travel versus time, as determined by the pedal travel sensor 24, is shown by line C, and the ratio of the master cylinder pressure to the pedal travel versus time is shown by line D. It has been discovered that as the vacuum pressure increases (i.e., vacuum pressure is lost), there is a corresponding decrease in the ratio of the master cylinder pressure to pedal travel (e.g., master cylinder pressure, in pounds per square inch, divided by pedal travel, in inches). Therefore, those skilled in the art will appreciate that there is an inverse correlation between the ratio of master cylinder pressure to pedal travel and the vacuum pressure.

Thus, by monitoring the master cylinder pressure and the brake pedal travel, the disclosed system 10 may estimate when the vacuum pressure within the vacuum booster 20 has dropped below a certain threshold, thereby requiring brake assist (e.g., activation of the hydraulic modulator assembly) to provide additional braking force.

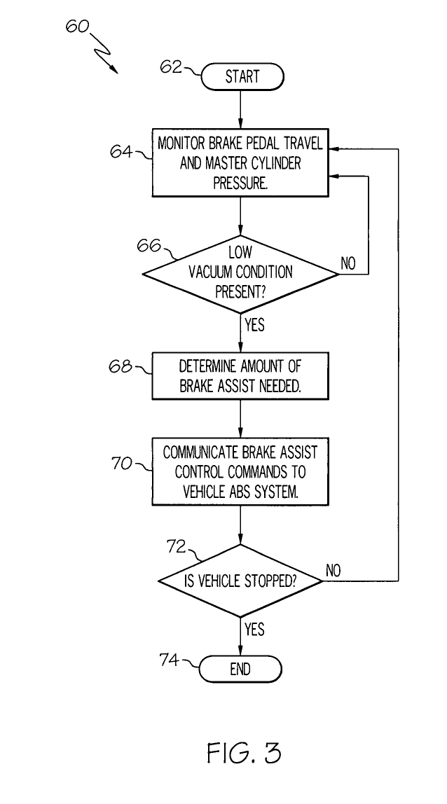

Referring to FIG. 3, a flow chart illustrating one aspect of a method of operation of the disclosed vacuum booster assist system 10, generally designated 60, is provided. The method 60 may begin at block 60 and, at block 62, the controller 12 may monitor the pressure in the master cylinder 16 and the travel of the brake pedal 22 by way of the master cylinder pressure sensor 18 and the brake pedal travel sensor 24, respectively. Those skilled in the art will appreciate that signals from the sensors 18, 24 may be monitored by the controller 12 continuously, periodically, randomly or the like.

At block 66, based upon the signals received from the sensors 18, 24, the controller 12 may estimate the vacuum pressure within the vacuum booster 20 and determine whether a low vacuum condition is present. For example, the controller 12 may calculate a ratio of master cylinder pressure to pedal travel based upon the signals received from the sensors 18, 24 and correlate the ratio to an estimated vacuum pressure value. The estimated vacuum pressure value may then be compared to predetermined or threshold values to determine whether a low vacuum condition is present. For example, estimated vacuum pressure values above 0.7 atmospheres may correspond to low vacuum conditions.

When a low vacuum condition is not detected (i.e., the vacuum pressure is sufficiently low), the method 60 may return to block 64 and continue monitoring the pressure in the master cylinder 16 and the travel of the brake pedal 22. However, when a low vacuum condition is detected, the method 60 may proceed to block 68 such that the controller 12 may determine what amount of brake assist is required to compensate for the low vacuum condition (i.e., the controller 12 may generate a brake assist command). The brake assist command may be dependent upon, or otherwise a function of, the estimated vacuum pressure value and/or the driver's brake input, as determined by the brake pedal travel sensor (e.g., the rate of change of brake pedal travel).

Referring to block 70, the controller 12 may communicate the brake assist command to the hydraulic modulator assembly 14 and the hydraulic modulator assembly 14 may provide the additional braking force necessary to satisfy the driver's intended brake effort. Referring to block 72, if, in response to the brake assist command, the vehicle comes to a stop, then the method 60 ends at block 74. However, if the vehicle continues to move after the driver's brake effort, the method 60 may return to block 64 and continue to monitor the pressure in the master cylinder 16 and the travel of the brake pedal 22.

At this point, those skilled in the art will appreciate that controller 12 may perform the correlations and determinations discussed above in various ways, such as a look-up table, a fitted equation, graphically or the like.

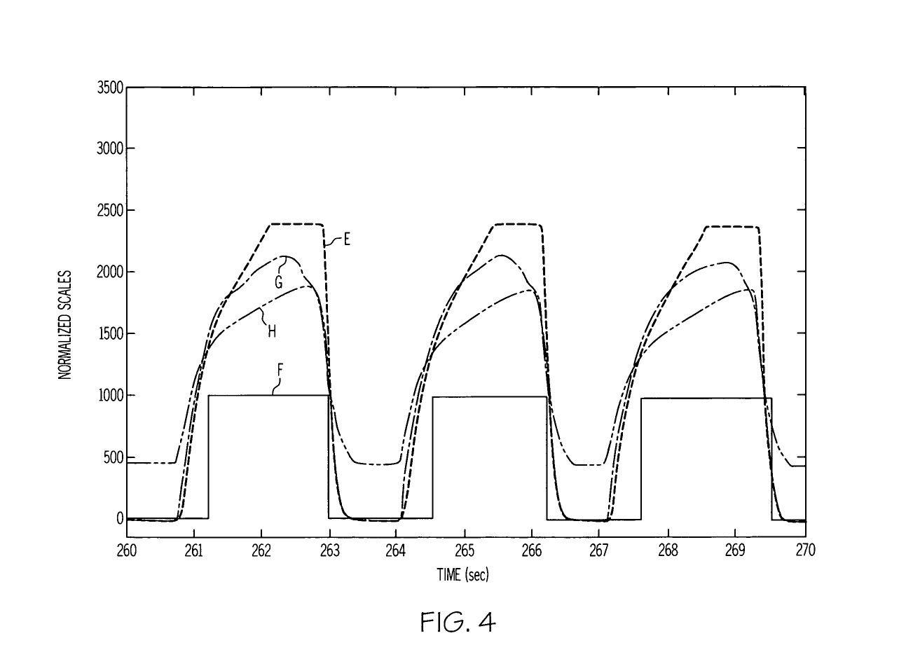

Thus, referring to FIG. 4, the downstream braking pressure (shown by line E) at the brake units 42, 44, 46, 48 may more closely resemble the driver's brake effort by actuating the hydraulic modulator assembly 14 in response to low vacuum conditions, as determined by monitoring the master cylinder pressure sensor 18 and brake pedal travel sensor 24. The actuation of brake assist (e.g., the actuation of the hydraulic modulator assembly 14) is shown by line F, the master cylinder pressure is shown by line G and the brake pedal travel is shown by line H.

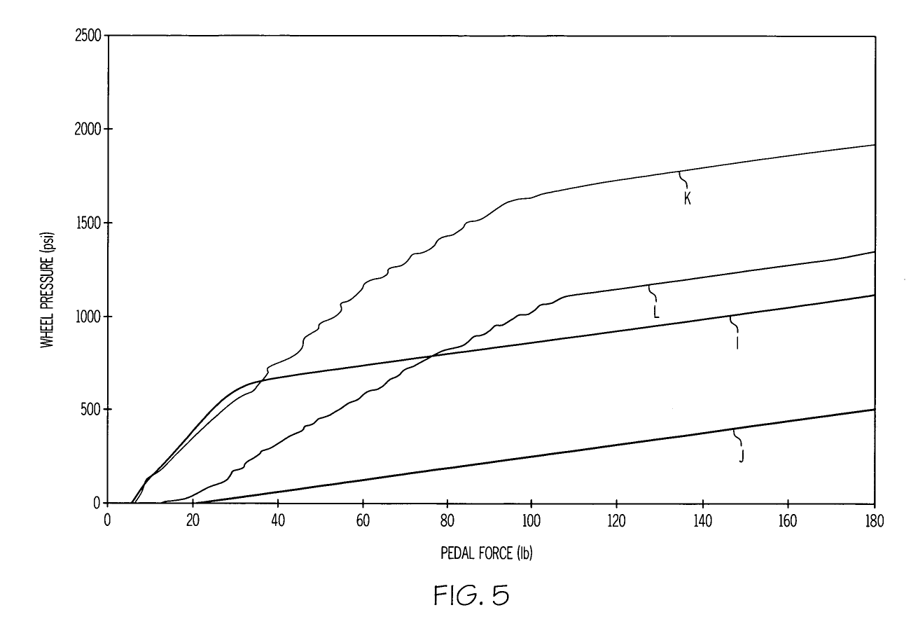

Referring to FIG. 5, a vehicle operating without the disclosed vacuum booster assist system 10 may have a downstream wheel pressure versus input pedal force profile shown by line I for an idle power condition and line J for a no power condition. In contrast, a vehicle operating with the disclosed vacuum booster assist system 10 may have a downstream wheel pressure versus input pedal force profile shown by line K for an idle power condition and line L for a no power condition.

Accordingly, the disclosed vacuum booster assist system 10 provides a reliable, robust and low cost estimate of vacuum run-out and driver's braking effort, and corresponding brake assist, based upon signals received from a master cylinder pressure sensor 18 and a brake pedal travel sensor 24. Given that master cylinder pressure sensors and a brake pedal travel sensors are currently common production parts and ABS systems are standard on most commercial cars, generally no additional cost is necessary to implement the disclosed vacuum booster assist system 10.

Although various aspects of the disclosed system and method for vacuum booster assist have been shown and described, modifications may occur to those skilled in the art upon reading the specification. The present application includes such modifications and is limited only by the scope of the claims.

What is claimed is:

1. A system for vacuum booster assist comprising:
a vacuum booster having an input and an output;
a brake pedal connected to said input of said vacuum booster;
a brake pedal travel sensor positioned to monitor travel of said brake pedal;
a master cylinder having an input and an output, said input of said master cylinder being connected to said output of said vacuum booster;
a master cylinder pressure sensor connection to said master cylinder to monitor a fluid pressure in said master cylinder;
a brake fluid pressurizing device in fluid communication with said output of said master cylinder; and
a controller in communication with said brake pedal travel sensor, said master cylinder pressure sensor and said brake fluid pressurizing device, wherein said controller is adapted to communicate a command signal to said brake fluid pressurizing device based upon signals received from said brake pedal travel sensor and said master cylinder pressure sensor.

2. The system of claim 1 wherein said vacuum booster is connected to a vacuum source.

3. The system of claim 2 wherein said vacuum source is a vehicle engine.

4. The system of claim 1 wherein said brake pedal is adapted to apply an input force to said vacuum booster.

5. The system of claim 4 wherein said vacuum booster is adapted to amplify said input force and transfer said amplified input force to said master cylinder.

6. The system of claim 1 wherein said brake fluid pressurizing device includes an electric pump and said command signal is adapted to selectively actuate said electric pump.

7. The system of claim 1 wherein said brake fluid pressurizing device is a hydraulic modulator assembly.

8. The system of claim 1 wherein said brake fluid pressurizing device and said controller are associated with an anti-lock braking system.

9. The system of claim 1 further comprising at least one brake unit.

10. The system of claim 9 wherein said brake fluid pressurizing device is in fluid communication with said brake unit.

11. The system of claim 9 wherein said brake fluid pressurizing device is adapted to selectively pressurize said brake unit in response to said command signal.

12. The system of claim 1 wherein said command signal is based upon a ratio of said fluid pressure in said master cylinder to said travel of said brake pedal.

13. The system of claim 1 wherein said vacuum booster includes a vacuum pressure and said controller communicates said command signal to said brake fluid pressurizing device when said vacuum pressure exceeds a predetermined threshold value.

14. A method for assisting a vacuum booster assembly apply a braking force to a brake unit, said vacuum booster assembly including a brake pedal, a vacuum booster and a master cylinder, said method comprising the steps of:
providing a brake fluid pressurizing device;
monitoring a travel of said brake pedal;
monitoring a pressure of said master cylinder;
correlating said monitored travel and said monitored pressure to an estimated vacuum pressure of said vacuum booster; and
when said estimated vacuum pressure exceeds a predetermined threshold value, actuating said brake fluid pressurizing device to increase said braking force.

15. The method of claim 14 wherein said brake fluid pressurizing device is a hydraulic modulator assembly.

16. The method of claim 14 wherein said monitoring said travel step includes receiving signals from a brake pedal travel sensor.

17. The method of claim 14 wherein said monitoring said pressure step includes receiving signals from a master cylinder pressure sensor.

18. The method of claim 14 wherein said correlating step includes determining a ratio of said monitored pressure to said monitored travel.

19. The method of claim 14 wherein said correlating and said actuating steps are performed by a controller.

20. The method of claim 14 wherein said brake fluid pressurizing device increases said braking force by a predetermined amount based upon said monitored travel.
